(19) United States
(12) Patent Application Publication
(10) Pub. No.: US 2014/0207507 A1
(43) Pub. Date: Jul. 24, 2014

(54) RECORDING, TRACKING AND EVALUATING SYSTEM

(71) Applicant: Giuseppe Cirianni, Victoria (AU)

(72) Inventor: Giuseppe Cirianni, Victoria (AU)

(21) Appl. No.: 14/240,513

(22) PCT Filed: Aug. 23, 2012
(86) PCT No.: PCT/AU2012/000987

§ 371 Date: Feb. 24, 2014

(30) Foreign Application Priority Data
Aug. 23, 2011 (AU) 2011903387

(51) Int. Cl. G06Q 10/06

(52) U.S. Cl. CPC G06Q 10/063114
USPC 705/7.15

(57) ABSTRACT

A system for continuously carry out a determination in real time of whether said signals received from the plurality of separate secondary inputs satisfy criteria derived from said project schedule with relation to the value of said clock means, update said output means status data, so as to output a communication a result of said determination and as per the communication template, and update said project schedule data as a function of a result of said determination.

### FIELD OF THE INVENTION

The present invention relates to a recording, tracking and evaluating system, and more particularly the invention relates to a recording, tracking and evaluating system for project control such as but not limited to the building and construction industry.

The invention can be applied in a number of industries for project management, however, for the sake of convenience the invention will be described as being applied to the building and construction industry.

### BACKGROUND TO THE INVENTION

The building and construction industry can be complex, as it uses a multitude of people and tradespersons from different specialist industries, trade activities and skills. Each will be required to perform various tasks on a single construction site at the same time or consecutively or at particular spaced times during the project, in order to complete a project within a certain period of time (usually a contractually agreed time).

Currently, the prior art does not provide a sufficient solution for organising and monitoring such complex construction sites having urgent completion deadline. As such, completion deadlines are not met and the project is extended beyond the deadline resulting in an increase of financial loss to the property owner and a loss of reputation in the construction company. In particular, the delay can lead to legal implications, court actions and an award of damages against the construction company.

Given the complexity of the construction site, it can be considerably difficult for a site manager to be aware at all times of all the individuals currently on site, the level of their progress in addition to performing quality checks all in a single point in time. As such, the site manager will not be aware of any delays as they arise but may become aware of the delay once significant consequences begin being observed.

As a multitude of people are involved, it is often difficult to identify the source of delay and address the source. In large construction projects a delay in one area will have a flow on effect and cause further delays in other aspects of the project and to other trades persons working on the project.

For example, a builder may need to set the foundation in order for an electrician to install multiple cables. Following installation the builders will be required to complete construction. If the builders delay in setting wall frames, the electricians will be delayed from installing the cables. If the builders delay for too long, the electricians may no longer be able to attend the site as they may have other job and commitments they need to attend to at different construction sites. Therefore extensive delays may further be experienced waiting for the electricians to become available.

The supervisors on site must set the trades persons in the correct sequence and order so that the trade work can operate effectively and efficiently in a project. However, with possible delays occurring due to not enough site resources, calculating inadequate time for each tradesperson or delay of materials, this will affect the next trade commencing on time and therefore the following trades are delayed in commencing their work.

Therefore, such delays may result in the absence or non-availability of certain individuals on a project given the extensive delay. It increases costs and inconvenience to all individuals involved and can result in legal action against the constructions company.

With regard to tradespersons, a prolonged duration of time in one project can result in loss of work and job opportunities on other construction sites. In particular, if there is a prolonged duration the tradespersons are left in a predicament where they are not needed on the construction site as intended because of the delay and therefore are not earning their wage. However, they cannot accept another job opportunity at another site because of their contractual agreement to the first site and therefore are left to sit it out until they are required.

It is therefore important that any delays are identified at the earliest stage so that they can be addressed and prevented from delaying the completion date. Further advantages of identifying the delay is recognising the reason for the delay such as where there is a material, equipment or resource shortage or whether the tradespersons experience level do not match that required by the construction site. As such, the site manager will be able to recognise the source of the delay immediately and the individuals attributing to the delay to then respond to the source accordingly.

In addition, as a result of the multitude of people involved and the strong aim of completing the project by the completion deadline, often the oversight of quality occurs. This is hazardous in the construction industry as any lack in quality and standards can result in failing building inspections, fines, ongoing repairs of defects, further delay of the project and the building being rendered unfit for purpose, time and money on demolishing works in order to recommence works correctly.

It is therefore an object of the invention to overcome or at least substantially ameliorate one or more of the disadvantages of the prior art or provide a viable alternative.

### SUMMARY OF THE INVENTION

In accordance with the invention there is provided a system for recording, tracking and evaluating for project control, comprising of:

a. a first input for receiving a plurality of input data to define details of at least part of a project including a predetermined level of completion of the at least part of a project;
b. a secondary input for receiving real time data related to the at least part of a project;
c. a determinator comparing the real time data of the secondary input with the input data of the first input in order to assess the at least part of a project and the gradual completion of the at least part of a project to the predetermined level of completion of the at least part of the project;
d. an automatic notificator sending output signals to one or more users defined in the input data according to the determinator assessment of completion to the predetermined level of the at least part of a project to the predetermined level according to the project;
wherein the at least part of the project assessed by the determinator provides automatic real-time control according to the defined at least part of a project.

The input data of the first input defines a plurality of predetermined subprojects to complete a project. It can define the characteristics of a plurality of subprojects. The input data of the first input can define the characteristics of a plurality of subprojects according to schedule, tasks, people and time.

Preferably at least two of the subprojects to be undertaken are at least partially concurrent.

The system for recording, tracking and evaluating can have the input data of the first input defining the following:

a. a first activation point at which time and position in the defined schedule a subproject is to begin;
b. a second completion point at which time and position in the defined schedule a subproject is to be completed;
c. at least one third gradual completion point at which time and position in the defined schedule a subproject is to have reached a defined gradual completion point;
d. at least one fourth review point at which time and position in the defined schedule a subproject is to be reviewed;

The determinator can compare the secondary input with the first input in order to assess if any one or more of
i. the first activation points has been reached and instigates the automatic notificator to sending output signals to the identified people in the input data to begin the at least part of a project to the predetermined level according to the project.
ii. any one or more of the second completion points has been reached and instigates the automatic notificator to sending output signals to the identified people in the input data to begin the at least part of a project to the predetermined level according to the project.
iii. if any one or more of the at least one of the third gradual completed points input has been reached and instigates the automatic notificator to sending output signals to the identified people in the input data to begin the at least part of a project to the predetermined level according to the project.
iv. if any one or more of the at least one of the fourth review points has been reached and instigates the automatic notificator to sending output signals to the identified people in the input data to begin the at least part of a project to the predetermined level according to the project.

Each subproject preferably represents at least one subcontractor or tradesperson.

The first input includes a predetermined gradual completion level of each subproject according to the gradual completion of one or more other subprojects to a predetermined level.

The subproject comprises of a plurality of assignments.

The secondary input receives real time data related to the at least part of a project.

The secondary input receives real time data related to location of the at least one subcontractor or tradesperson involved in the subproject.

The secondary input is entered by an automatic GPS locator connected with a subcontractor or tradesperson of each assignment.

According to one particular aspect, the present invention provides a system for recording, tracking and evaluating, comprising of:
a) A first input of a plurality of predetermined subprojects to complete a project;
b) A secondary input to identify gradual completion of the subprojects to a predetermined level;
c) A determinator comparing the secondary input with the first input in order to assess the subprojects and the gradual completion of the subprojects to the predetermined level according to the project;
d) An automatic notificator sending output signals to one or more users according to the determinator assessment of completion to the predetermined level of at least one of the subprojects to initiate completion of one or more subprojects or concurrently;
e) wherein each subprojects assessed by a determinator provides real-time data according to each of the plurality of subprojects.

The first input defining the characteristics of the subproject. Each subproject preferably representing at least on subcontractor or tradesperson. The first input including a predetermined gradual completion level of each subproject according to the gradual completion of one or more other subprojects to a predetermined level.

The subproject preferably comprising of a plurality of assignments.

The secondary input is entered by a swipe card by a user at the completion of each assignment.

The determinator identifies the gradual completion of the subprojects to a predetermined level to provide a percentage result of the progress towards completion of the project.

The output is determined by the determinator's assessment of the gradual completion of the assignment to a predetermined level.

Once the determinator has recognised from the secondary input that the predetermined level has been reached, an automatic output is sent.

The automatic output, in one form, signals for a quality check to be performed.

The automatic output, in a second form, signals for a second subproject to commence.

The input of the secondary input provides redefining of the system by the determinator.

The assignments or subprojects can be clustered. In one embodiment, the assignments or subprojects are clustered according to the site manager.

The invention in one form provides a system for recording, tracking and evaluating for project control, utilising of a computer network including:

a. a first input for receiving a plurality of input data to define details of at least part of a project including a predetermined level of completion of the at least part of a project, the first input adapted to receive project schedule, said project schedule data defining times by which specified activities are to be performed by a plurality of users undertaking to complete at least part of the project;
b. first memory means adapted to store said project schedule data;
c. second memory means to store a communication template;
d. first output means adapted to output a communication signal as a function of output means status data and the communication template
e. a plurality of separate secondary inputs remote from the first input and operable in relative locations of the at least part of a project for receiving, real time data related to the at least part of a project;
f. clock means;
g. a communication means which when instructed by the determinator forms as an automatic notificator and sends output communications to one or more users defined in the input data according to the determinator assessment of completion to the predetermined level of the at least part of a project to the predetermined level according to the project; and
h. first processing means forming a determinator comparing the real time data of the secondary inputs with the input data of the first input in order to assess the at least part of a project and the gradual completion of the at least part of a project to the predetermined level of completion of the at least part of the project; said first processing means configured to
i. continuously carry out a determination in real time of whether said signals received from the plurality of separate secondary inputs satisfy criteria derived from said project schedule with relation to the value of said clock means,
ii. update said output means status data, so as to output a communication a result of said determination and as per the communication template,
iii. update said project schedule data as a function of a result of said determination,
wherein the at least part of the project assessed by the determinator provides automatic real-time control according to the defined at least part of a project.

At least some of the plurality of separate secondary inputs are portable and GPS connected to provide real time position location relative to the at least part of a project.

The plurality of remote secondary input with interface means adapted to send signals to the automatic project controller operate over a different communication channel to the output communicated used by automatic notificator in sending output communications to one or more users.

The input data of the first input defines the communication template in relation to the activation points including the following:

a. a first activation point at which time and position in the defined schedule a subproject is to begin;
b. a second completion point at which time and position in the defined schedule a subproject is to be completed;
c. at least one third gradual completion point at which time and position in the defined schedule a subproject is to have reached a defined gradual completion point;
d. at least one fourth review point at which time and position in the defined schedule a subproject is to be reviewed;
and instigates one or more communications according to the communication template to the predefined one or more users relevant to the schedule point including relating to:
i. instruction to commence defined next step;
ii. instruction to report, progress;
iii. instruction to make defined scheduled time;
iv. instruction to review.

### BRIEF DESCRIPTION OF THE DRAWINGS

Embodiments of the invention will now be described, by way of example only, with reference to the accompanying drawings, in which:

FIG. 1 is a diagrammatic representation of the system of recording, tracking and evaluating in accordance with one embodiment of the invention;

FIG. 2 is a diagrammatic view of secondary inputs to the determinator in accordance with one embodiment of the invention of FIG. 1,

FIG. 3 is a diagrammatic representation of the interaction of users such as subcontractors with real time data input and automatic communication from notificator in accordance with one embodiment of the invention of FIG. 1;

FIG. 4 is a diagrammatic representation of the direction of the notificator and instigation of multiple subprojects by the notificator to illustrate the flow of subprojects in accordance with in accordance with one embodiment of the invention of FIG. 1;

FIG. 5 is a diagrammatic representation of the direction of the notificator of the system of recording, tracking and evaluating in accordance with one embodiment of the invention, illustrating the flow and overlap of the subprojects;

FIG. 6 is a diagrammatic representation of the operation of a notificator where a subproject has not been completed by the expected completion date;

FIG. 7 is an example of input data received by input means determining subprojects and corresponding scheduling and overlapping of timing of subprojects;

FIG. 8 is an example listing of tasks to be completed in one of a plurality of subprojects such as identified in FIG. 7

FIG. 9 is an example of the control of the determinator and the comparison of received real time data from secondary input to the input data of the first input in accordance with one embodiment of the invention of FIG. 1;

FIG. 10a is a table representation of a subproject template according to one embodiment of the invention where input data provides for the intended completion date, the number of days remaining to complete the subproject, the number of assignments to be completed per day to complete the subproject, a running total of the work completed to date;

FIG. 10b is a table representation of a subproject template that has been redefined with entry of the secondary input data where the secondary input data provides for an increase in the number of completed assignments higher than required in a single day providing redefining and readjustment of the figures

FIG. 10c is a table representation of a subproject template that has been redefined with entry of the secondary input data where the secondary input data provides for a decrease in the number of completed assignments than required which results in the determinator redefining and readjusting the figures to maintain the finish date;

FIGS. 11a, b is a flow chart illustrating the mode of operation of the system of recording, tracking and evaluating in accordance with one embodiment of the invention.

### DESCRIPTION OF PREFERRED EMBODIMENTS OF THE INVENTION

The invention provides for a system of recording, tracking, prompting and evaluating projects such as construction and building projects. The invention allows for quality assurance, live status of the project, prompting of all direct parties and acting to limit delay.

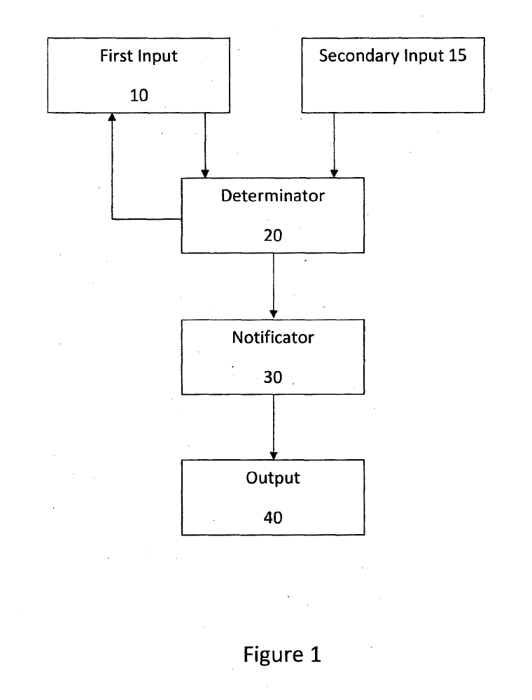

In one embodiment of the invention, as presented in FIG. 1, the system comprises of: first input 10 for receiving input data of a plurality of predetermined subprojects 50 to complete a project; a secondary input 15 to identify gradual completion of the subprojects 50; a determinator 20 assessing the subprojects 50 and the gradual completion of the subprojects 50 according to the project; a notificator 30 providing output signals to one or more users according to the determinator's 20 assessment of completion of at least one of the subprojects 50 to initiate completion of a second of the subprojects 50 or a second and third subproject 50 concurrently; wherein each subproject 50 is assessed by a determinator 20 to provide real-time data assessment according to the stage of completion of each of the plurality of subprojects 50.

The system for recording, tracking and evaluating for project control, more particularly comprises of a first input 10 for receiving a plurality of input data to define details of at least part of a project including a predetermined level of completion of the at least part of a project; a secondary input 15 for receiving real time data related to the at least part of a project; a determinator 20 comparing the real time data of the secondary input with the input data of the first input in order to assess the at least part of a project and the gradual completion of the at least part of a project to the predetermined level of completion of the at least part of the project; an automatic notificator 30 sending output signals to one or more users defined in the input data according to the determinator assessment of completion to the predetermined level of the at least part of a project to the predetermined level according to the project, so that the at least part of the project assessed by the determinator provides automatic real-time control according to the defined at least part of a project

The project is the objective of the construction; for example, the building of an 18 storey building. The subprojects are the stages within the project required to achieve the objective; for example, the laying of the concrete, installation of cable wires etc. The first input 10 for receiving input data is required to define and formulate the characteristics and requirements of the subproject 50 for completion. The first input 10 for receiving input data therefore requires entry of the project and more particularly the plurality of subprojects 50 making up the project.

With respect of the project, the first input 10 for receiving input data can comprise of details that identify the site and the specifications and the subprojects required to achieve the project. Therefore, first input 10 for receiving input data includes the location and size of the construction site, local councils, permit requirements and expiry details, specifications of the buildings to be built, details of the engineers, constructions companies, architects etc.

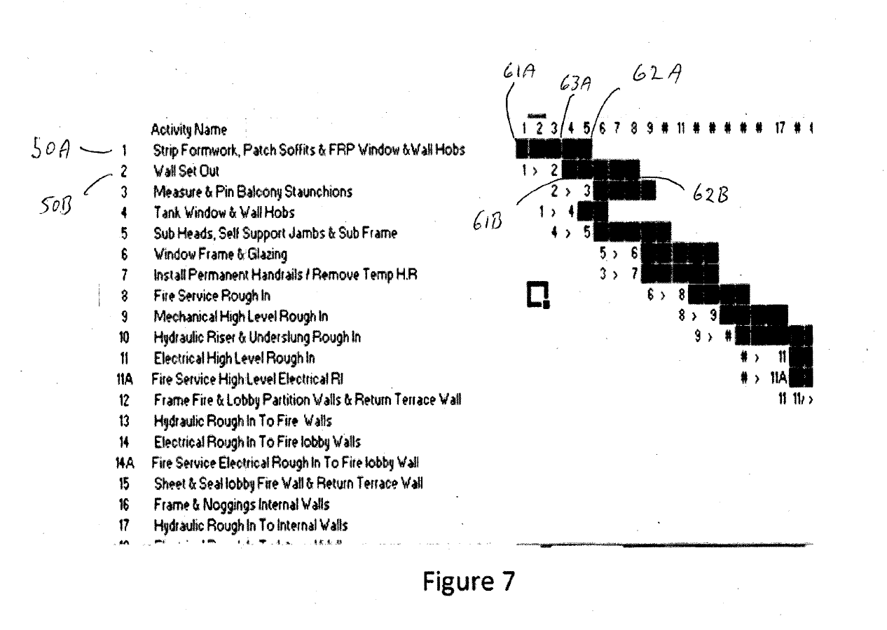

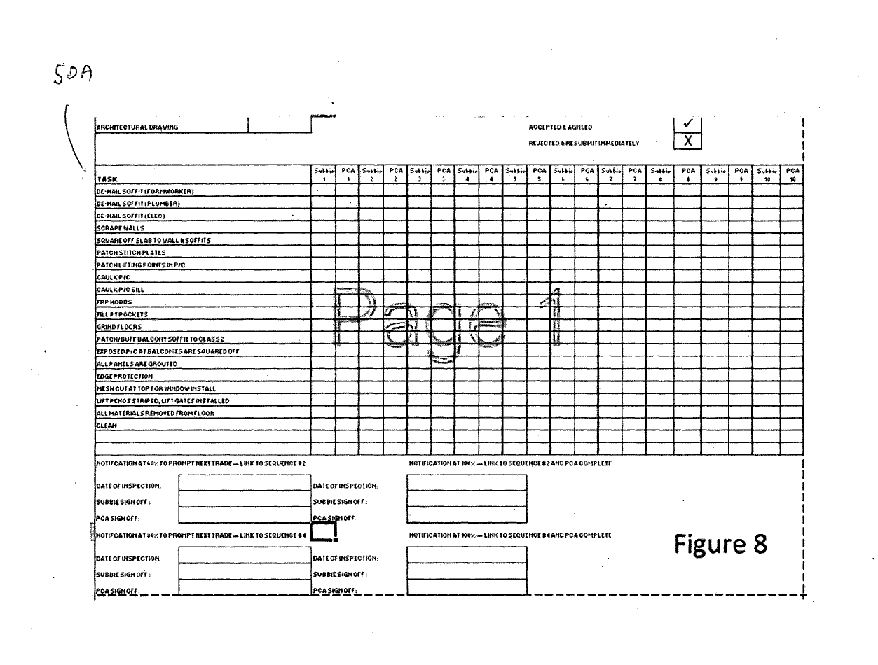

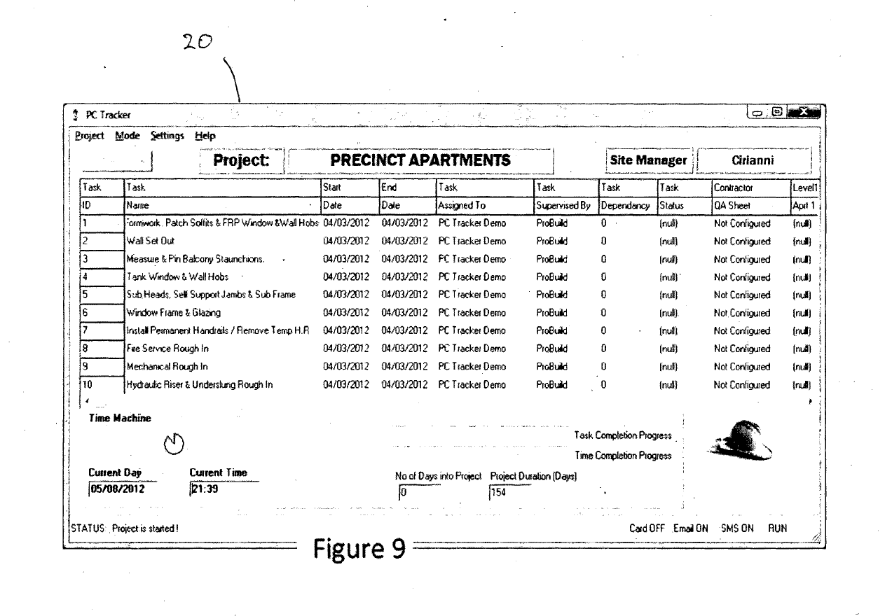

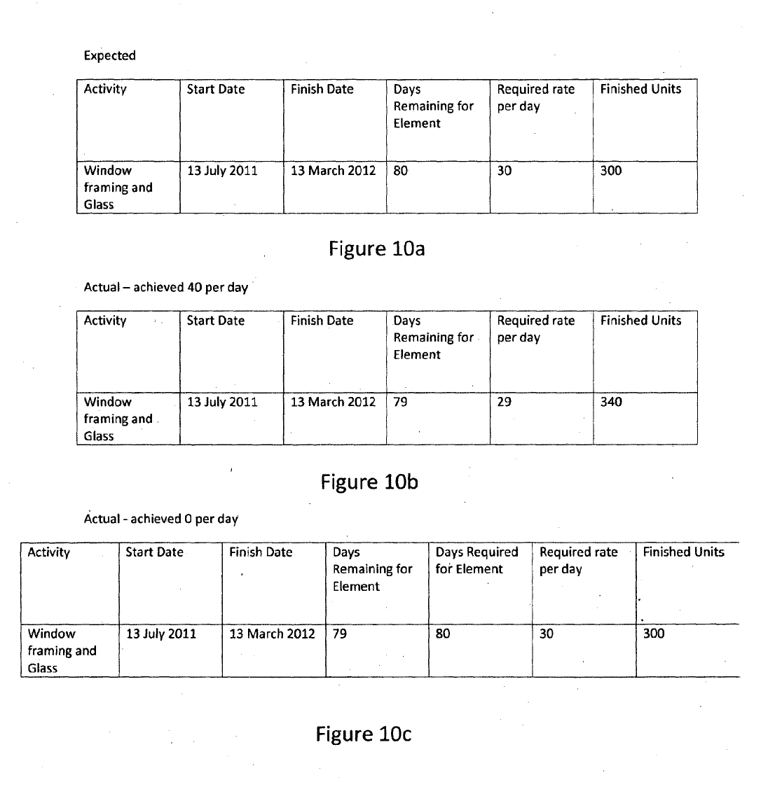

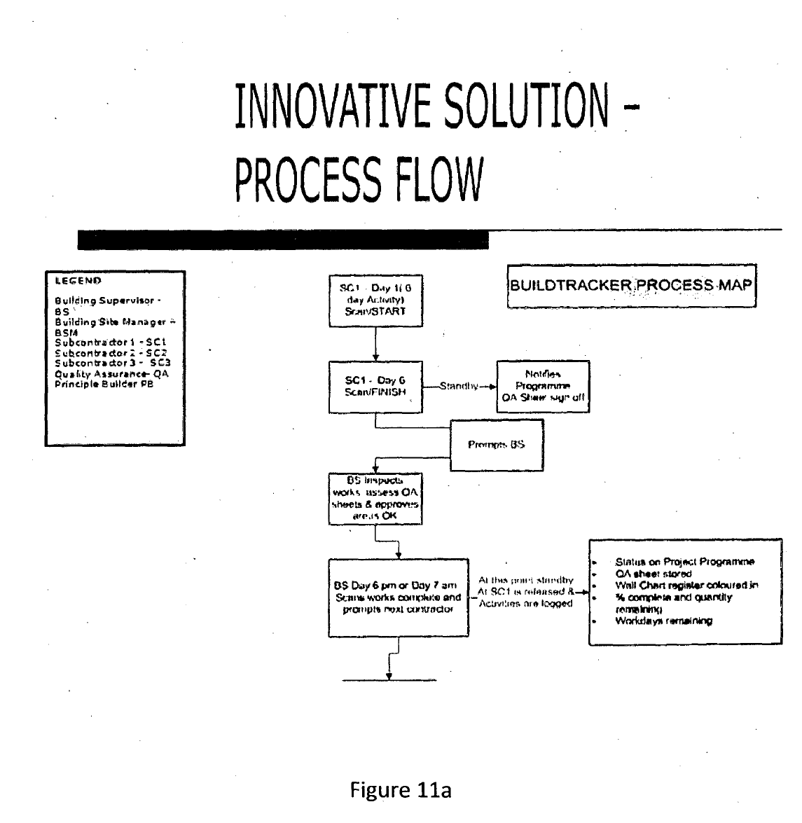

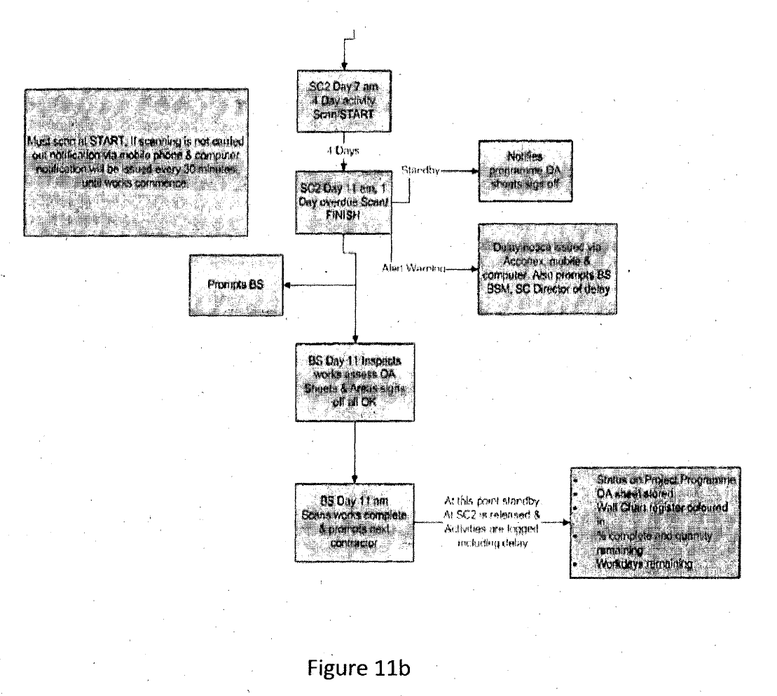

With regard to the subproject 50, as can be seen by examples in FIGS. 7 and 8 details of different subprojects 50A, 50B can be entered to determine who is to be working on the site, what is to be done, what is the aim at the end of the subproject what are the assignment's within each subproject that will assist in achieving the aim, what is the estimated time of completion of each assignment and therefore the subproject. The subprojects herein will be described as representing one or more subcontractors on a project.

The input data of the first input 10 can defines a first activation point 61A, 62A at which, time and position in the defined schedule of the subprojects 50A, 50B is to begin respectively. It can define a second completion point 62A, 62B at which time and position in the defined schedule of the subprojects 50A, 50B are to be completed respectively. Further it can define at least one third gradual completion point 63A at which time and position in the defined schedule a subproject is to have reached a defined gradual completion point which in this case could correspond with the start of the second subproject 50B.

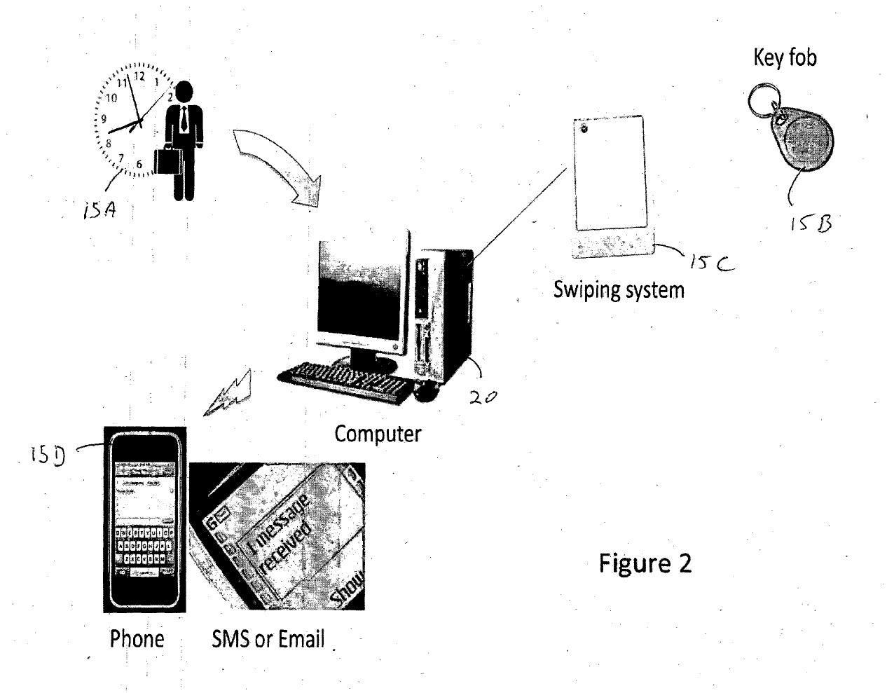

As shown in FIG. 2 the real time data that is received through secondary input 15 to the determinator 20 can be by time clock 15A designating time entry/out and merely time expiration related to the subcontractor or the like in the subproject. Other means can be a key fob 15B that acts as an automatic GPS and by definition of building site and comparison undertaken by the determinator the location of the subcontractor on-site can be tracked. This can also be beneficial in large multi storey projects where different subprojects are being undertaken by same subcontractor. Allocation of duty or effort is automatically determined by relative location. A further input can be a card swiping system 15C with swipe stations at suitable locations. However a further option is the use of phone for providing the secondary input. This is particularly beneficial as it can provide the other element of the invention of a communication channel to the subcontractor such that the notificator can when assessed by the determinator send messages to the subcontractor.

Clearly therefore the determinator maintains active project control and if the third gradual completion point 63A is not achieved at the required time the second subproject starting time can be moved and the determinator maintain the schedule in live form. However other third gradual completion points 63A can be identified initially such that upon reaching those stages the notificator automatically sends communication to check progress so that timetable is maintained automatically and the critical third gradual completion point 63A is achieved at the required time.

The input data can also include at least one fourth review point at which time and position in the defined schedule a subproject is to be reviewed. This can be between the start point and the finish point or at the gradual completion point or other time as predefined. This can be a quality check or other check as required to proceed with project.

It can be seen that the advantage here is that the building supervisor will be able to clearly identify all the authorised personnel within a given time on a day. In addition, in the case of an emergency, it provides an easy access list of personnel names. Therefore, such a feature acts as both a convenient mechanism for occupational health and safety and further in order to monitor contractors. In addition, if a contractor or tradesperson has not swiped in the tradesperson can be notified by a notificator 40 in addition to the building supervisor or other allocated individual.

It can be seen that system provides for a virtual template of a subproject 50 that can be manipulated and defined by the first input 10 for receiving input, data to create or develop a project.

Therefore, each subproject 50 can be further broken down into assignments that are required to be completed or provide daily/weekly targets that lead to the completion of the subproject 50 within the estimated completion date and thereby allow for the project to be completed by the completion date.

The assignment can comprise of a number of set targets leading up to the completion of the subproject or can be duration of time such as an hour or a day. The subcontractor can complete each assignment and confirm each task has been completed as first input 10 for receiving input data in the form of secondary input data 15.

Each assignment and or subproject can be clustered. The cluster can occur according to a common element, such as all the electricians can be clustered and all the painters can be clustered, or can be clustered, for example, according to a supervisor. In a large construction building of 18 storeys for example, a cluster assists in maintaining accountability. The system recognises the clusters in order to have the notificator send to the correct individual/s.

The secondary input data 15 provides a real time indication as to the progress of (a) the completion of each individual assignment (b) the completion of the subproject, (c) the time lapse and (d) the progress of completion of the project.

As illustrated in FIGS. 7a to 7c the sub project is the laying of cables by the electricians, the assignment is the required units per day, being the meter in cables required to be laid. The calculation of the assignment can be automated by the system according to a database of generic or template figures or can be entered manually.

The secondary input data 15 can be inputted from a number of sources. It can be inputted into the system in one embodiment on a central computer or on an ancillary computer linked to a main frame. Alternatively, the system can allow for a link between telecommunication devices in order to allow the input of secondary input data 15 from a remote location.

Alternatively, the invention can provide for a swipe card mechanism. In one form the swipe card can be entered by users as they enter the site. The swipe card can be personalised or be provided with personal identification to allow first input 10 for receiving input data to be retained on each individual on the site.

The swipe card mechanism therefore allows for the system to identify the number of personnel, the identity of the personnel, the hours worked to collate a statistical assessment and to also assist and combine the system with payroll.

The system allows for automatic updates. As illustrated by the A line in FIG. 2, the determinators assessment as to the completion of the project relative to the expected date of completion is in fluid motion and in fluid connection with the first input 10 for receiving input data and output data 40.

Therefore, if the system detects an increase in the number of swipe actions for builders for example who are responsible for completing a particular sub project 50, the system recognises that an, increase in number of builders then originally planned will result in the assignments within the subproject to be completed earlier than intended. The determinator 20 recognises and assesses the result to readjust the related subprojects and notifications to realign with the new expected date of completion.

Therefore alterations to a subproject 50 will alter the project to always indicate the impact of a single aspect of the construction relative to the whole project to give a whole picture approach to the project.

Therefore, if subprojects 50 are completed earlier than their expected completion date, the secondary input identifying the gradual completion of the project, redefines the system to ensure that the remaining subprojects and the trade persons responsible for the subprojects follow suit.

The swipe mechanism is also used by authorised personnel at predetermined objectives following the completion of an assignment or subproject. For example the swipe card can be swiped when all the equipment has been delivered, the card can be swiped when the foundation has been laid etc. This provides a mechanism of continually updating the system to reflect real time approach. Such a swiping action will also initiate a further subproject, movement onto the next assignment or a quality check.

Alternatively to the card system can be a networking system where each individual can have a beeper or mobile phone allowing for them to not be restricted to a particular location in order to enter the progress but to allow entry from a remote location.

The subproject 50 in one form can be a quality check 55. The quality check 55 can provide a notification to a building supervisor or other authorised personnel to undertake the responsibility of assessing the quality of the assignments within the completed subproject according to predetermined standards.

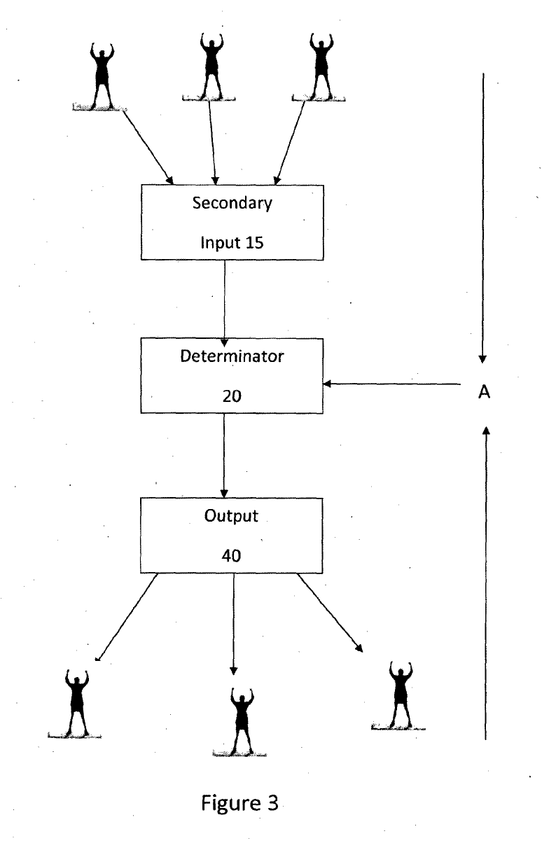

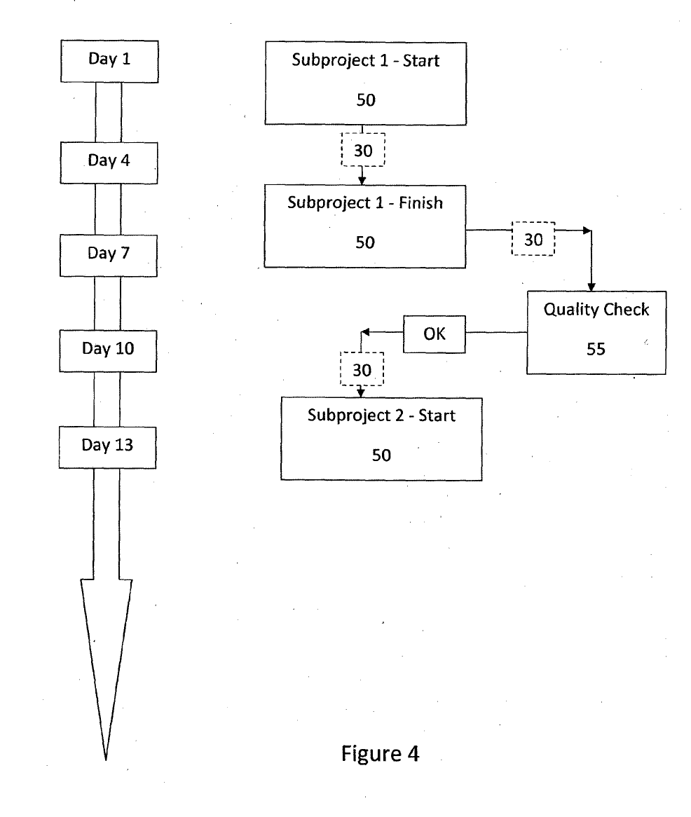

The template allows for the plurality of subprojects 50 to be grouped or related. Such a set relationship allows for the timing of the completion of each subproject 50 and the assignment within each subproject 50 to be linked. As illustrated in FIGS. 3 and 4, this allows for a number of results.

In one form, the completion of a first subproject 50 leads to the initiation of a second predetermined subproject 50. Alternatively, the completion of one or more assignments within a subproject can initiate a second subproject 50. The initiation of a second subproject 50 can be dependent on the completion of an assignment or a first subproject. Alternatively, the initiation of a second subproject 50 can be timed to start on day 4 for example.

The system therefore provides a secondary 55 input allowing authorised personnel to update the systems to illustrate the progress of the subproject and project. In order to assist in tracking the progress, authorised personnel can have access to a computer or system.

The system further provides for a determinator 20 to assess the subproject 50 and the gradual completion of the subproject 50 relative to the project as a whole. That is, the determinator 20 recognises when the subproject 50 has reached a particular level of completion or a number of assignments have been completed.

The system recognises both a vertical and horizontal mode of communication. The system recognise that, particularly in the construction industry, (a) some subprojects must be completed in full before a further subproject 50 can begin (b) some subprojects 50 can be completed simultaneously (c) some projects 50 can begin at various points during the first subproject 50.

The system allows for all three variations. With particular regard to (c), the determinator 20 recognises that the subproject 20 has reached a particular level of completion by determining the progress of the completion of the assignments, and therefore initiates the notificator 30 to provide an output data 40.

The output data 40 is the outgoing signal reporting to a predetermined user whether and which subproject is to begin. The outdoing data 40 is dictated by the determinator 20.

The invention further provides for a notificator 30. The First input 10 for receiving input data can further include details of the nature and the names of the individuals and the organisations in which they are employees of. Further the first input 10 for receiving input data includes the type and form of the notifications to be sent out by the notificator 30, identifying the authorised personnel, who will be notified and when they will be notified, identifying who and at what stage during the project a user will be identified to perform a quality check.

The notificator 30 transfers to the output data 40 to one or more predetermined uses according to the determinator's assessment of completion of at least one of the subprojects to initiate completion of a second subproject.

As the output data 40 also identified delays, the notificator 30 can be used to identify different parties of any delays where an assignment or subproject takes longer then pre-planned.

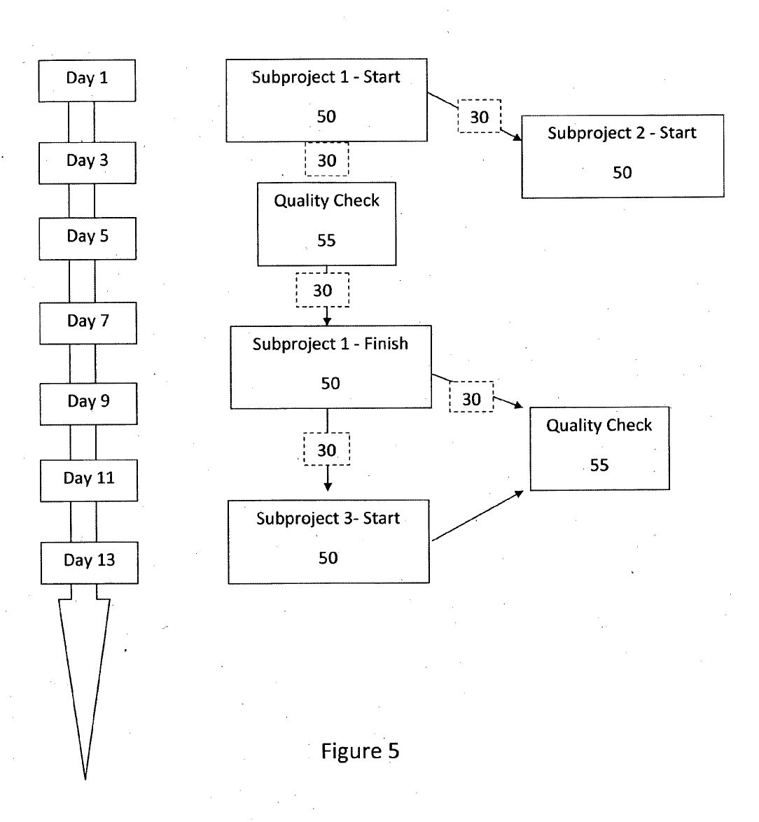

In addition, the notificator 30 provides a means of advising a subcontractor responsible for a subproject to begin and to further notify an authorised business supervisor to perform a quality check. Alternatively, it can advise when materials or resources fall below a certain level and an order for tools or material is required. In FIG. 5, the notificator 30 operates to inform the recorded parties of a delay.

The notificator can be via email or beeper system. Alternatively it can be an automatic message via usual telecommunication lines. The notificator can be sent to a number of parties simultaneously. For example, it can be sent to the business supervisor and engineer in addition to the subcontractors required to begin a second subproject. Alternatively, the subcontractor, area manager, director can be notified where the subproject is delayed or not completed.

Therefore, in summary, according to one embodiment of the invention, the notificator 30 notifies a user of:

Firstly, the building supervisor can be notified to perform a quality check, to reassess the equipment or materials required.

Secondly, the notificator can notify the second subcontractor who can begin without waiting for the first subcontractor's completion of the subproject as it may only require completion of a number of assignments rather than the whole first subproject. For example a second project may begin when the first project has been 80% completed.

Thirdly, the notificator can notify the first subcontractor to continue or notify them whether they are required to delay. For example, the first sub-contractors may need to await for cement to dry. The notificator therefore acts to prompt all parties to carry out their work at the earliest date.

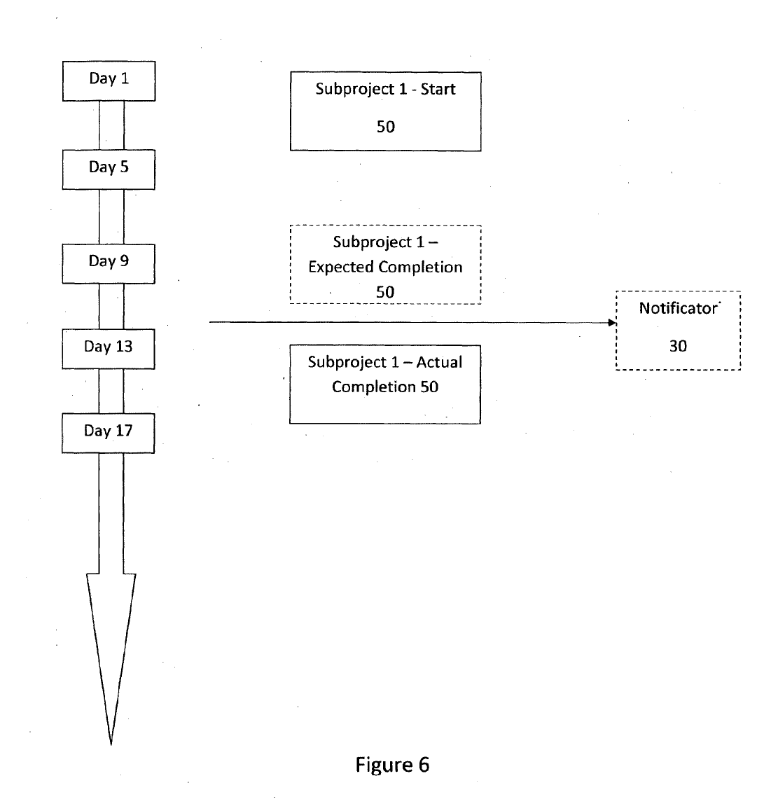

When the building supervisor or site manager performs a quality check, a check list, as provided in FIG. 6, can be provided to them. The building supervisor will be required to check off the items that have been met. This can be done manually onto a physical sheet or onto a computer network for downloading onto the system.

In doing so, the system provides for “real time” information of the status and progress of the subproject 50, the project and the relationship between the two. It can further provide a calculation of percentage of work completed according to the number of days remaining to the completion date or the number of total sub projects completed. Such a value can be recalculated daily, hourly automatically taking into the account the input data entered.

The system is advantageous in reducing operational supervisory costs whilst ensuring quality workmanship will assist in accountability from sub contractors, reducing or eliminating delays, or increasing costs in re doing or reworking tasks that did not satisfy the quality checks.

The system is continually updated in order to provide up to date, real-time data as to the progress and status of the project and the status moving closer to the progress or achievement relative to the completion date.

It can therefore be seen that the invention provides a mechanism of ensuring quality is maintained in all aspects of the building process, and control of each and every subcontractor.

Those of skill in the art will appreciate that such modifications or changes to the particular embodiments exemplified can be made without departing from the scope of the invention. All such modifications and changes are intended to be included within the scope of the invention as defined in the following claims.

1-30. (canceled)

31. A system for recording, tracking and evaluating for project control, comprising:
a. a first input receiving a plurality of input data to define details of at least part of a project including a predetermined level of completion of the at least part of a project;
b. a secondary input receiving real time data related to the at least part of a project;
c. a determinator comparing the real time data of the secondary input with the input data of the first input in order to assess the at least part of a project and the gradual completion of the at least part of a project to the predetermined level of completion of the at least part of the project; and
d. an automatic notificator that sends output to one or more users defined in the input data according to the determinator assessment of completion to the predetermined level of the at least part of a project to the predetermined level according to the project;
wherein the at least part of the project assessed by the determinator provides automatic real-time control according to the defined at least part of a project.

32. A system for recording, tracking and evaluating according to claim 31, wherein the input data of the first input defines the characteristics of a plurality of subprojects according to schedule, tasks, people and time.

33. A system for recording, tracking and evaluating according to claim 32, wherein the at least two of the subprojects to be undertaken are at least partially concurrent.

34. A system for recording, tracking and evaluating according to claim 33, wherein the input data of the first input defines the following:
a. a first activation point at which time and position in the defined schedule a subproject is to begin;
b. a second completion point at which time and position in the defined schedule a subproject is to be completed;
c. at least one third gradual completion point at which time and position in the defined schedule a subproject is to have reached a defined gradual completion point; and
d. at least one fourth review point at which time and position in the defined schedule a subproject is to be reviewed.

35. A system for recording, tracking and evaluating according to claim 34, wherein the determinator compares the secondary input with the first input in order to assess if any one or more of the first activation points has been reached and instigates the automatic notificator to sending output signals to the identified people in the input data to begin the at least part of a project to the predetermined level according to the project.

36. A system for recording, tracking and evaluating according to claim 35, wherein the determinator compares the secondary input with the first input in order to assess if any one or more of the second completion points has been reached and instigates the automatic notificator to sending output signals to the identified people in the input data to begin the next at least part of a project to the predetermined level according to the project.

37. A system for recording, tracking and evaluating according to claim 36, wherein the determinator compares the secondary input with the first input in order to assess if any one or more of the at least one of the third gradual completed points input has been reached and instigates the automatic notificator to sending output signals to the identified people in the input data to begin the next at least part of a project to the predetermined level according to the project.

38. A system for recording, tracking and evaluating according to claim 37, wherein the determinator compares the secondary input with the first input in order to assess if any one or more of the at least one of the fourth review points has been reached and instigates the automatic notificator to sending output signals to the
identified people in the input data to review the at least part of a project to the
predetermined level according to the project.

39. A system for recording, tracking and evaluating according to claim 32, wherein each subproject preferably represents at least one subcontractor or tradesperson, wherein the secondary input receives real time data related to location of the at least one subcontractor or tradesperson involved in the subproject.

40. A system for recording, tracking and evaluating according to claim 39, wherein the first input includes a predetermined gradual completion level of each subproject according to the gradual completion of one or more other subprojects to a predetermined level.

41. A system for recording, tracking and evaluating according to claim 39, wherein the secondary input receives real time data related to the at least part of a project.

42. A system for recording, tracking and evaluating according to claim 41, wherein the secondary input is entered by an automatic GPS locator connected with a subcontractor or tradesperson of each assignment.

43. A system for recording, tracking and evaluating according to claim 41, wherein the secondary input is entered by a swipe card by a subcontractor or tradesperson at the completion of each assignment.

44. A system for recording, tracking and evaluating according to claim 32, wherein the determinator compares the secondary input with the first input in order to assess the subprojects and the gradual completion of the subprojects to the predetermined level according to the project wherein the output is determined by the determinator's assessment of the gradual completion of the assignment to a predetermined level.

45. A system for recording, tracking and evaluating according to claim 32, wherein the automatic notificator sends output signals to one or more users according to the determinator assessment of completion to the predetermined level of at least one of the subprojects to initiate completion of one or more subprojects or concurrently.

46. A system for recording, tracking and evaluating according to claim 32, wherein once the determinator has recognised from the secondary input that the predetermined level has been reached, an automatic output is sent wherein the automatic output, in one form, signals for a quality check to be performed and wherein the automatic output, in a second form, signals for a second subproject to commence.

47. A system for recording, tracking and evaluating according to claim 32, wherein the input of the secondary input provides redefining of the system by the determinator.

48. A system for recording, tracking and evaluating for project control, using a computer network, comprising:
a. a first input receiving a plurality of input data to define details of at least part of a project including a predetermined level of completion of the at least part of a project, the first input adapted to receive project schedule, said project schedule data defining times by which specified activities are to be performed by a plurality of users undertaking to complete at least part of the project;
b. a first memory adapted to store said project schedule data;
c. a second memory that stores a communication template;
d. a first output adapted to output a communication signal as a function of output status data and the communication template;
e. a plurality of separate secondary inputs remote from the first input and operable in relative locations of the at least part of a project for receiving real time data related to the at least part of a project;
f. a clock;
g. a communication arrangement which when instructed by the determinator forms as an automatic notificator and sends output communications to one or more users defined in the input data according to the determinator assessment of completion to the predetermined level of the at least part of a project to the predetermined level according to the project;
h. a first processor forming a determinator comparing the real time data of the secondary inputs with the input data of the first input in order to assess the at least part of a project and the gradual completion of the at least part of a project to the predetermined level of completion of the at least part of the project; said first processor configured to:
i. continuously carry out a determination in real time of whether said signals received from the plurality of separate secondary inputs satisfy criteria derived from said project schedule with relation to the value of said clock,
ii. update said output status data, so as to output a communication a result of said determination and as per the communication template,
iii. update said project schedule data as a function of a result of said determination,
wherein the at least part of the project assessed by the determinator provides automatic real-time control according to the defined at least part of a project.

49. A system for recording, tracking and evaluating according to claim 48, wherein at least some of the plurality of separate secondary inputs are portable and GPS connected to provide real time position location relative to the at least part of a project.

50. A system for recording, tracking and evaluating according to claim 48, wherein the plurality of remote secondary input with interface means adapted to send signals to the automatic project controller operate over a different communication channel to the output communicated used by automatic notificator in sending output communications to one or more users.

51. A system for recording, tracking and evaluating according to claim 48, wherein the input data of the first input defines the communication template in relation to the activation points including the following:
a. a first activation point at which time and position in the defined schedule a subproject is to begin;
b. a second completion point at which time and position in the defined schedule a subproject is to be completed;
c. at least one third gradual completion point at which time and position in the defined schedule a subproject is to have reached a defined gradual completion point;
d. at least one fourth review point at which time and position in the defined schedule a subproject is to be reviewed;
and instigates one or more communications according to the communication template to the predefined one or more users relevant to the schedule point including relating to:
i. instruction to commence defined next step;
ii. instruction to report progress;
iii. instruction to make defined scheduled time;
iv. instruction to review.
